(19) United States
(12) Patent Application Publication
(10) Pub. No.: US 2007/0155351 A1
(43) Pub. Date: Jul. 5, 2007

(54) RECEIVING APPARATUS

(75) Inventors: Yasuo Oba, Shiga (JP); Hideo Nagata, Shizuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/696,996

(22) Filed: Apr. 5, 2007

(30) Foreign Application Priority Data
Apr. 7, 2006 (JP) 2006-106360

(51) Int. Cl. H04B 1/18

(52) U.S. Cl. 455/188.2

(57) ABSTRACT

In an AGC circuit using an IF detection method, to detect an IF level of a mixer output, a variable low-pass filter is provided before a detector, in addition to a low-pass filter for extracting an IF signal. Analog television channels which are interfering waves are defined according to digital television channels and a cut-off frequency of the variable low-pass filter is set such that levels of interfering analog television signals can be detected by the detector and that an unwanted signal that is not desirable to be inputted to the detector is suppressed by a signal outputted from a mixer.

### BACKGROUND OF THE INVENTION

1. Field of the Invention

The present invention relates to a receiving apparatus such as a tuner unit in a mobile television receiver, particularly, a low power consumption and small digital television tuner to be used in a digital television installed on a mobile phone or the like. Note that the tuner unit can be applied not only to a digital television tuner but also to an analog television tuner.

2. Description of the Background Art

A problem with a television tuner for mobile reception includes that a signal to be inputted from an antenna includes not only a desired signal but also multiple interfering signals and thus a receiving condition changes depending on a receiving channel. In a stationary television receiver, a receiving condition is fixed and sufficient space can be reserved and thus sufficient measures are taken against interfering signals. On the other hand, in a mobile receiver, there is a demand for miniaturization and low power consumption; thus, normally it is difficult to take sufficient measures against interference.

When a digital television tuner function is installed on a mobile phone, call signals to be transmitted and received become interfering signals for a television tuner, which, in some cases, has a great influence on reception performance. Particularly, in a digital television tuner, as interfering signals, conventional analog television signals are considered that are present other than a desired digital television signal. Analog television signals to be transmitted from a television station have greater power than digital television signals. When analog television signals of a strong electric field are inputted to a mobile phone as interfering waves, IM (intermodulation) distortion caused by the analog television signals which are interfering waves occurs. By the IM distortion falling in a digital television signal band which is a desired wave, the reception performance may be degraded.

In a television tuner, to obtain optimal reception performance in an input range of a desired wave signal from a weak electric field to a strong electric field by avoiding the influence of noise or the influence of IM distortion, an AGC function is indispensable that automatically controls the operating level of a circuit according to an input electric field level.

Furthermore, the digital television tuner installed on the above-described mobile phone requires an AGC function that adjusts the operating level according to interfering signals, to obtain optimal reception performance according to the input levels of a variety of interfering waves. Namely, when a desired signal level is high, an AGC operation is less susceptible to the influence of interfering signals; however, when a desired signal level is low, an AGC operation is susceptible to the influence of interfering signals. Thus, the AGC operating level needs to be changed according to the levels of interfering signals.

Conventionally, as AGC of a television tuner, a television tuner having an AGC circuit using an IF detection method shown in FIG. 4 or a television tuner having an AGC circuit using an RF detection method shown in FIG. 5 is known.

In FIG. 4, reference numeral 401 denotes an RF input terminal that accepts, as input, an RF signal received via an antenna, reference numeral 402 denotes a bandpass filter, reference numeral 403 denotes a variable gain amplifier (gain control amplifier), reference numeral 404 denotes a mixer, reference numeral 405 denotes a local oscillator, reference numeral 406 denotes a low-pass filter that allows an IF signal to pass therethrough, reference numeral 407 denotes an IF output terminal, reference numeral 408 denotes a detector, and reference numeral 409 denotes an AGC control circuit.

The operation of the digital television tuner configured in the above-described manner will be described. An RF signal inputted through the RF input terminal 401 passes through the bandpass filter 402. The RF signal is then amplified by the variable gain amplifier (gain control amplifier) 403 and the amplified RF signal is inputted to an RF input terminal of the mixer 404. Meanwhile, a signal from the local oscillator 405 is inputted to a local input terminal of the mixer 404. The mixer 404 outputs, as an IF signal, a differential frequency between the inputted RF signal and local signal. The IF signal outputted from the mixer 404 passes through the low-pass filter 406 and is then outputted from the IF output terminal 407.

On the other hand, the IF signal which is an output from the low-pass filter 406 is inputted to the detector 408. The detector 408 detects a level of the inputted IF signal and the detected signal is inputted to the AGC control circuit 409. An output from the AGC control circuit 409 is inputted to a control terminal of the variable gain amplifier (gain control amplifier) 403.

In the television tuner with the AGC circuit using the IF detection method configured in the above-described manner, level control is performed, i.e., the gain of the variable gain amplifier 403 is controlled, such that the level of an IF signal which is an output from the low-pass filter 406 is always at a certain level or less even if the level of an RF signal to be inputted fluctuates.

On the other hand, since the cut-off frequency of the low-pass filter 406 is set to allow a signal to pass through an IF signal band, for interfering signals outside the IF signal band, an output from the low-pass filter 406 is attenuated and an AGC operation does not depend on the interference signals.

In FIG. 5, reference numeral 501 denotes an RF input terminal that accepts, as input, an RF signal received via an antenna, reference numeral 502 denotes a bandpass filter, reference numeral 503 denotes a variable gain amplifier (gain control amplifier), reference numeral 504 denotes a mixer, reference numeral 505 denotes a local oscillator, reference numeral 506 denotes a low-pass filter that allows an IF signal to pass therethrough, reference numeral 507 denotes an IF output terminal, reference numeral 508 denotes an RF amplifier, reference numeral 509 denotes a detector, and reference numeral 510 denotes an AGC control circuit.

The operation of the digital television tuner configured in the above-described manner will be described. A signal inputted through the RF input terminal 501 passes through the bandpass filter 502. The signal is then amplified by the variable gain amplifier (gain control amplifier) 503 and the amplified signal is inputted to an RF input terminal of the mixer 504. Meanwhile, a signal from the local oscillator 505 is inputted to a local input terminal of the mixer 504. The mixer 504 outputs, as an IF signal, a differential frequency signal between the inputted RF signal and local signal. The IF signal outputted from the mixer 504 passes through the low-pass filter 506 and is then outputted from the IF output terminal 507.

On the other hand, the RF signal which is an output from the variable gain amplifier (gain control amplifier) 503 is amplified by the RF amplifier 508 and then the amplified RF signal is inputted to the detector 509. The detector 509 detects a level of the inputted RE signal and the detected signal is inputted to the AGC control circuit 510. An output from the AGC control circuit 510 is inputted to a control terminal of the variable gain amplifier (gain control amplifier) 503.

In the television tuner with the AGC circuit using the RF detection method configured in the above-described manner, level control is performed, i.e., the gain of the variable gain amplifier 503 is controlled, such that the level of an RF signal which is an input to the mixer 504 is always at a certain level or less even if the level of an RF signal to be inputted fluctuates.

However, in the conventional configuration, i.e., the television tuner with the AGC circuit using the IF detection method shown in FIG. 4, since a signal that is an output from the low-pass filter 406 is detected, an AGC operation is performed on a digital television signal of a desired wave; however, analog signals of interfering waves are suppressed by the low-pass filter 406 and thus an AGC operation cannot be performed on the analog signals. That is, in interfering waves, AGC does not operate and thus IM distortion caused by the interfering waves occurs; as a result, the IM distortion falls in a digital television signal band which is a desired wave, causing a problem of degradation of reception performance.

In the television tuner with the AGC circuit using the RF detection method shown in FIG. 5, since level detection is performed on an output from the variable gain amplifier (gain control amplifier) 503 that performs an amplification operation in all television signal bands, levels of analog television signals which are interfering waves are sufficiently detected. Hence, the television tuner has a circuit configuration suitable to perform an AGC operation on interfering waves. Note, however, that the television tuner with the AGC circuit using the RF detection method shown in FIG. 5 requires the RF amplifier 508 to adjust the input level of the detector 509.

The reason for that is as follows. Specifically, in the IF detection method, the mixer has a gain and thus an output signal level sufficient for level detection can be obtained. On the other hand, in the RF detection method, detection is performed before the mixer and thus an RF signal level is insufficient. Since the sensitivity of the detector is almost the same for RF and IF, in the RF detection method an amplifier needs to be added to adjust the input level of the detector.

The RF amplifier 508 is not present in the AGC circuit using the IF detection method and requires an operation in a band of several hundred megahertz which is a television signal band; thus, generally, a current needs to be increased as compared with an IF-band signal processing circuit.

However, the addition of a high-current RF amplifier causes a big problem, particularly when the RF amplifier is used in a mobile television receiver that requires miniaturization and low power consumption. Namely, in the RF detection method, an RF amplifier needs to be provided, hindering miniaturization. In addition, there is a tendency that an amplifier cannot obtain performance unless the amplifier is designed such that in circuit design the higher the frequency the larger the power consumption. Thus, the addition of an RF amplifier hinders a reduction in power consumption.

As described above, in a digital television tuner, a signal to be inputted from an antenna includes not only a desired digital television signal but also conventional analog television signals as interfering waves. In the tuner, an AGC circuit that minimizes the influence of IM distortion caused by interfering waves needs to be provided; however, in a conventional AGC circuit using an IF detection method, it is difficult to detect interfering waves.

Moreover, there is a problem that power consumption is large in a conventional AGC circuit using an RF detection method, and thus, there is a problem in using such an AGC circuit in a mobile phone or the like that requires low power consumption.

### SUMMARY OF THE INVENTION

The present invention is made to solve the foregoing problems. An object of the present invention is therefore to provide a receiving apparatus having an AGC function that suppresses the influence of IM distortion caused by interfering wave signals, and implementing low power consumption.

In the present invention, to solve a problem that interference waves cannot be detected in a receiving apparatus such as an AGC circuit television tuner using an IF detection method, an extraction location of an IF detection output is changed from an IF-low-pass filter output to a mixer output, a variable low-pass filter is provided before a detector, and a cut-off frequency of the variable low-pass filter is changed according to a receiving condition, whereby interference waves can be detected.

Specifically, the receiving apparatus comprises: a gain control amplifier that amplifies a received RF signal; a local oscillator; a mixer that mixes an output signal from the gain control amplifier with an output signal from the local oscillator; a first low-pass filter that extracts an IF signal from an output signal from the mixer; a second low-pass filter that extracts a desired frequency component from the output signal from the mixer; a detector that detects a level of an output signal from the second low-pass filter; and an AGC control circuit that feeds back an output from the detector, as a gain control signal, to the gain control amplifier, wherein a cut-off frequency of the second low-pass filter is changed according to a receiving condition.

According to this configuration, for example, by defining analog television channels which are interfering waves, according to digital television channels, and setting a cut-off frequency of the second low-pass filter such that levels of interfering analog television signals can be detected by the detector and that an unwanted signal that the detector does not want to detect is suppressed by a signal outputted from the mixer, an AGC function by an IF detection method is enabled. In AGC using an RF detection method, a current fed through an RF amplifier is the order of several milliamperes and when the power supply voltage is the order of 3 volts, there is a 10 milliwatt or more increase in power. Comparing with this, in the present invention, by adopting an LPF composed of a passive element, the apparatus can be operated at a current value that is an order of magnitude lower than that for conventional cases, making it possible to implement low power consumption. Moreover, the apparatus does not have an influence on an original IF signal output operation.

In the receiving apparatus of the present invention, it is preferable that the second low-pass filter have an n-bit logic control line and control of 2 to nth power states be performed according to control data to be provided to the n-bit logic control line, whereby the cut-off frequency is adjusted.

According to this configuration, the state of the cut-off frequency of the second low-pass filter is set to be limited to 2 to the nth power states.

Furthermore, in the receiving apparatus of the present invention, it is preferable that in the second low-pass filter, a state of the cut-off frequency be switched according to two reception states, VHF and UHF.

According to this configuration, low-pass filter characteristics are set based on VHF or UHF. When VHF having lower frequencies is received, since interfering wave frequencies are also low and thus are present near a desired signal, the low-pass filter does not need to have a wide band. To suppress, by the low-pass filter, an image signal (whose frequency is the sum of an RF frequency and a local oscillator frequency) generated in the mixer, the band of the low-pass filter is set to a low value such that an image frequency is sufficiently attenuated. When UHF having higher frequencies and a wider band is received, to detect levels of interfering waves, the cut-off frequency of the low-pass filter is set to a high value. Although an image frequency generated in the mixer needs to be suppressed, the image frequency itself is high as compared with VHF and thus by setting the cut-off frequency of the low-pass filter to a high value, an AGC function by an IF detection method is enabled. Since an AGC function by an IF detection method is performed, unlike AGC by an RF detection method, an amplifier does not need to be additionally provided, making it possible to implement low power consumption. Moreover, the apparatus does not have an influence on an original IF signal output operation.

The present invention can provide a receiving apparatus (e.g., a digital television tuner) having an advantageous effect that an AGC circuit using an IF detection method is implemented by providing a second low-pass filter before a detector, defining analog television channels which are interfering waves, according to digital television channels, and changing a cut-off frequency of the second low-pass filter such that levels of interfering analog television signals can be detected by the detector and that an unwanted signal that the detector does not want to detect is suppressed by a signal outputted from a mixer. Since the AGC circuit using the IF detection method is implemented, unlike an AGC circuit using an RF detection method, an amplifier that consumes power does not need to be provided, making it possible to implement low power consumption.

### BRIEF DESCRIPTION OF THE DRAWINGS

FIG. 1 is a block diagram showing a configuration of a digital television tuner according to a first embodiment of the present invention;

FIG. 2 is a block diagram showing a configuration of a digital television tuner according to a second embodiment of the present invention;

FIG. 3 is a block diagram showing a configuration of a digital television tuner according to a third embodiment of the present invention;

FIG. 4 is a block diagram showing a configuration of a conventional television tuner employing an AGC circuit using an IF detection method;

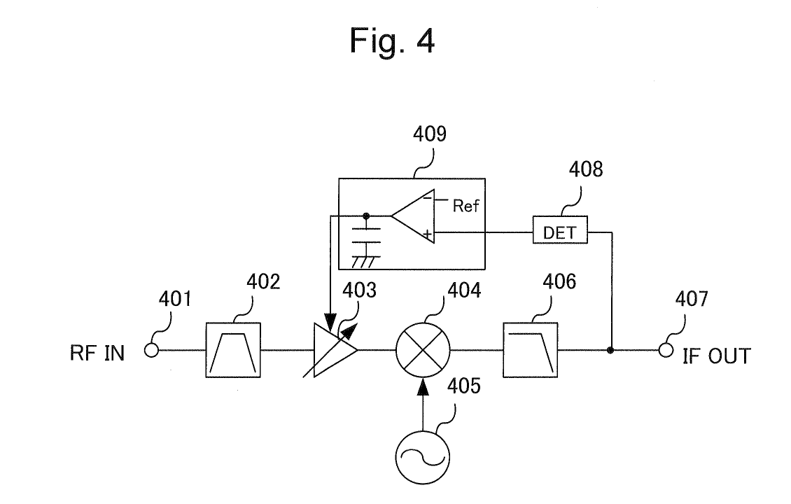

FIG. 5 is a block diagram showing a configuration of a conventional television tuner employing an AGC circuit using an RF detection method;

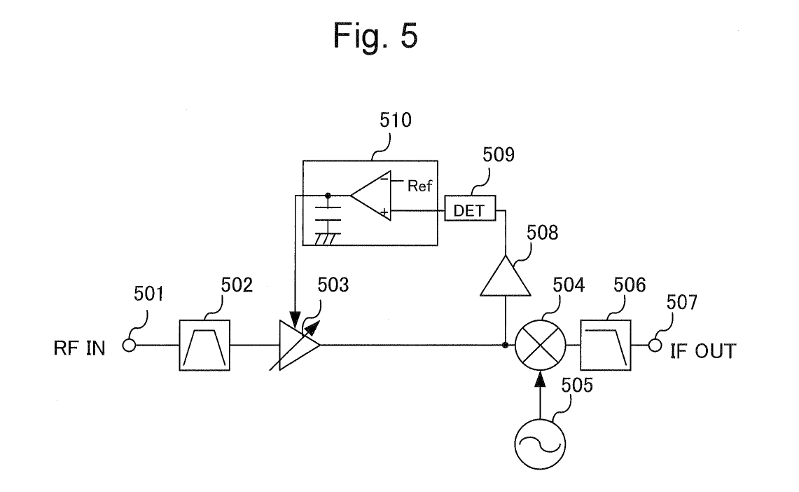

FIG. 6A is a circuit diagram for describing a configuration of a variable low-pass filter used in the present invention and FIG. 6B is an equivalent circuit diagram for describing an operation of the variable low-pass filter used in the present invention; and

FIG. 7 is a circuit diagram showing a current source for controlling a cut-off frequency of the variable low-pass filter used in the present invention.

### DESCRIPTION OF THE PREFERRED EMBODIMENTS

Digital television tuners which are receiving apparatuses according to embodiments of the present invention will be described below using the drawings.

### First Embodiment

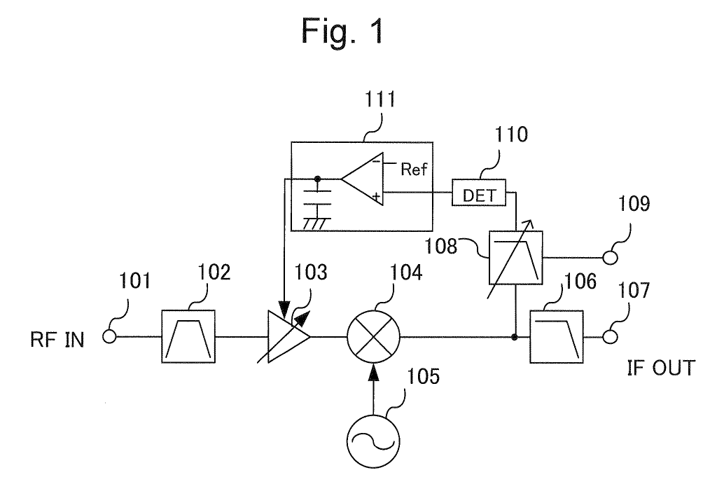

A digital television tuner according to a first embodiment of the present invention is shown in FIG. 1. In FIG. 1, reference numeral 101 denotes an RF input terminal that accepts, as input, an RF signal received via an antenna, reference numeral 102 denotes a bandpass filter, reference numeral 103 denotes a low-noise variable gain amplifier (gain control amplifier), reference numeral 104 denotes a mixer, reference numeral 105 denotes a local oscillator, reference numeral 106 denotes a low-pass filter that allows an IF signal to pass therethrough, reference numeral 107 denotes an IF output terminal, reference numeral 108 denotes a variable low-pass filter disposed before a detector, reference numeral 109 denotes a variable low-pass filter control terminal, reference numeral 110 denotes the detector, and reference numeral 111 denotes an AGC control circuit.

The operation of the digital television tuner configured in the above-described manner will be described.

First, a signal inputted through the RF input terminal 101 passes through the bandpass filter 102 and is then amplified by the variable gain amplifier (gain control amplifier) 103. The signal amplified by the variable gain amplifier 103 is inputted to an RF input of the mixer 104. An output signal from the local oscillator 105 is inputted to a local input of the mixer 104. The mixer 104 outputs a low-frequency IF signal which is a differential frequency between the RF signal and the local signal. The IF signal outputted from the mixer 104 passes through the low-pass filter 106 and is then outputted from the IF output terminal 107.

On the other hand, the IF signal outputted from the mixer 104 passes through the variable low-pass filter 108. Then, a level of the IF signal is detected by the detector 110. The signal detected by the detector 110 is inputted to the AGC control circuit 111. An output of the AGC control circuit 111 is connected to a gain control terminal of the variable gain amplifier 103. In the AGC control circuit 111, an error amplifier (an operational amplifier in the AGC circuit) controls the variable gain amplifier (gain control amplifier) 103 such that a difference of a detector output voltage and a reference voltage Ref is constant. By the operation of the AGC control circuit 111, an AGC operation is performed to always suppress the output level of the mixer 104 to a certain value or less, regardless of whether a signal is an interfering wave or a desired wave. As described above, regardless of whether a signal is a desired wave signal or an interfering wave signal, an AGC operation function based on input power is performed.

Here, the cut-off frequency of the variable low-pass filter 108 is determined according to a receiving condition. For example, analog television channels which are interfering waves are defined according to digital television channels and the cut-off frequency of the variable low-pass filter 108 is set such that levels of interfering analog television signals can be detected by the detector and that an unwanted signal that the detector does not want to detect is suppressed by a signal outputted from the mixer. For example, switching is performed between VHF and UHF signal inputs. In VHF having lower frequencies and a narrower band, the cut-off frequency does not need to be set to a high value and thus is set to a low value. In UHF having higher frequencies and a wider band, the cut-off frequency is set to a high value. In UHF, since the bandwidth is about 300 megahertz, upon reception of channel 13 at an end of the band, if there is an interfering signal of channel 62, the signal is about 300 megahertz and thus the cut-off frequency is set to 300 megahertz or higher. Upon reception of the VHF band, in a bandwidth of channels 4 to 12, the bandwidth is about 50 megahertz and thus an interfering signal of a maximum of 50 megahertz comes along; accordingly, the cut-off frequency is set to 50 megahertz or higher.

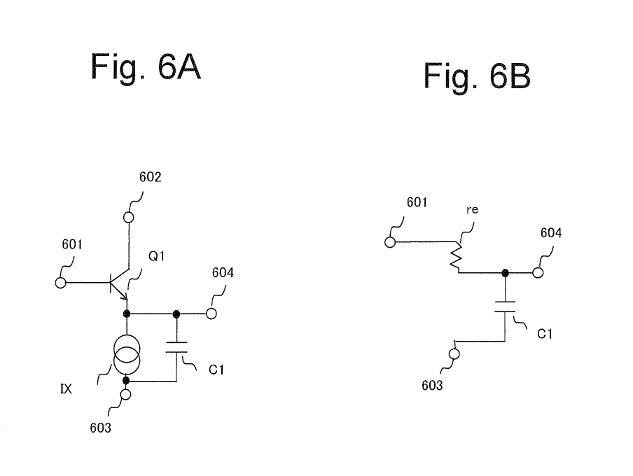

An exemplary variable low-pass filter to be used in the present invention is shown in FIG. 6A. In FIG. 6A, reference numeral 601 denotes a signal input terminal, reference numeral 602 denotes a power supply terminal, reference numeral 603 denotes a ground terminal, reference numeral 604 denotes a signal output terminal, reference numeral Q1 denotes an emitter-follower transistor, reference numeral IX denotes a current source of the emitter-follower transistor Q1, and reference numeral C1 denotes a capacitor.

FIG. 6B shows an equivalent circuit of FIG. 6A. The symbol re denotes the dynamic resistance of an emitter-base junction of the emitter-follower transistor Q1 and re is expressed such that re=kT/qIX where the symbol k denotes the Boltzmann's constant, the symbol T denotes the absolute temperature, and the symbol q denotes the unit charge. When T=27° C., kT/q is about 26 millivolts.

It can be seen from FIG. 6B that the circuit of FIG. 6A serves as a low-pass filter and its cut-off frequency is expressed as follows:
fc=1/(2reC1).
Here, since the dynamic resistance re changes according to the current IX, by changing the current IX, the cut-off frequency can be changed. For example, when IX=100 microamperes and C1=1 picofarad, the cut-off frequency fc is about 612 megahertz and when IX=10 microamperes, the cut-off frequency fc is about 61.2 megahertz.

The calculation steps of the cut-off frequency will be briefly described. As described above, the resistance re is expressed by the following equation:
re=kT/(q·IX).
In the equation, since kT/q≈26 mV, when IX=100 μA, re≈2.6 kΩ. When IX=10 μA, re≈26 kΩ. When these resistance values of the resistance re of 2.6 kilo-ohms and 26 kilo-ohms, along with a capacitance value of the capacitor C1 of 1 picofarad, are substituted into the calculation equation for the cut-off frequency, cut-off frequencies fc of 612 megahertz and 61.2 megahertz are obtained.

In the receiving apparatus according to the first embodiment, the cut-off frequency is set by changing the current value.

In the present invention, for the capacitor C1, by using parasitic capacitances of a constant-current source connected to the output terminal 604, a circuit of a subsequent stage, and the like, the circuit size is reduced.

According to such a digital television tuner according to the first embodiment of the present invention, analog television channels which are interfering waves are defined according to digital television channels and the cut-off frequency of the variable low-pass filter 108 is set such that levels of interfering analog television signals can be detected by a detector and that an unwanted signal that the detector does not want to detect is suppressed by a signal outputted from a mixer, whereby an AGC function by an IF detection method can be accomplished that can solve the problem that analog interfering waves cannot be detected. Thus, the detection of interfering waves is enabled and an AGC operation can be performed with the inclusion of interfering waves, the generation of IM distortion caused by interfering waves can be suppressed, and the degradation of reception performance can be reduced. Moreover, the tuner does not have an influence on an original IF signal output operation. Furthermore, since the tuner does not employ an AGC circuit using an RF detection method, an amplifier does not need to be separately added, making it possible to minimize power consumption.

### Second Embodiment

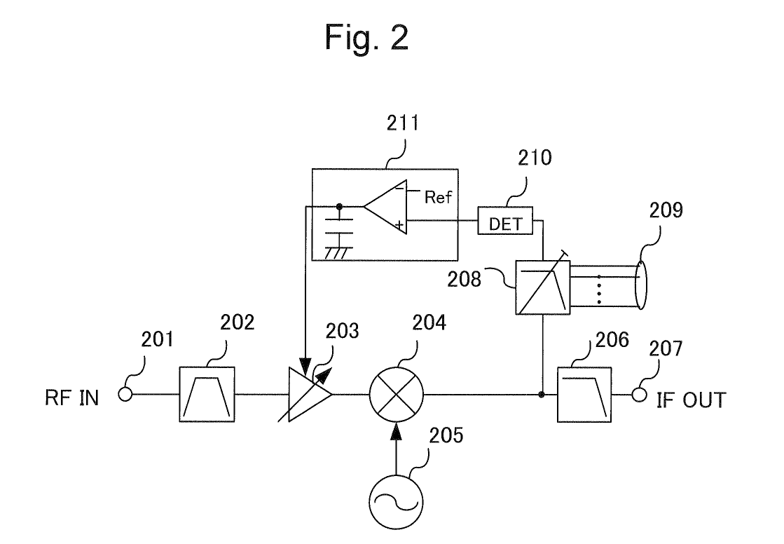

A digital television tuner according to a second embodiment of the present invention is shown in FIG. 2.

In FIG. 2, reference numeral 201 denotes an RF input terminal that accepts, as input, an RF signal received via an antenna, reference numeral 202 denotes a bandpass filter, reference numeral 203 denotes a variable gain amplifier (gain control amplifier), reference numeral 204 denotes a mixer, reference numeral 205 denotes a local oscillator, reference numeral 206 denotes a low-pass filter that allows an IF signal to pass therethrough, reference numeral 207 denotes an IF output terminal, reference numeral 208 denotes a variable low-pass filter disposed before a detector, reference numeral 209 denotes a variable low-pass filter control terminal, reference numeral 210 denotes the detector, and reference numeral 211 denotes an AGC control circuit. The cut-off frequency of the variable low-pass filter 208 can be controlled, by an n-bit logic control line (n is any integer), to 2 to the nth power states.

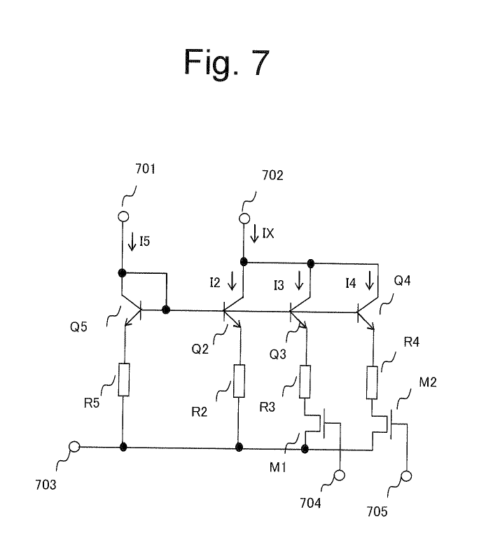

FIG. 7 shows an exemplary current source by a 2-bit logic control line. By applying this current source to the current source IX of the variable low-pass filter in FIG. 6A, control of a cut-off frequency by a 2-bit control signal is made possible.

In FIG. 7, reference numeral 701 denotes a reference current input terminal, reference numeral 702 denotes a current output terminal, reference numeral 703 denotes a ground terminal, reference numerals 704 and 705 each denote a control terminal, reference numerals Q2 to Q5 each denote a transistor that composes a current mirror, reference numerals R2 to R5 each denote a resistor that composes a current mirror, and reference numerals M1 and M2 each denote an NchMOS transistor that composes a control switch.

In FIG. 7, when the control terminals 704 and 705 are high level, the relationship between current values is expressed as follows:
Im=(R5/Rm)·I5(m=2 to 4).
The current output is such that IX=I2+I3+I4.

When the voltages at the control terminals 704 and 705 each are set to a low level or high level, currents I3 and I4 each are zero or a finite value and the current IX can be controlled to four different current values. A reference current IS can be easily provided by using a constant-current source in an integrated circuit. By adding the same combination as that of the transistor Q3, the resistor R3, and the NchMOS transistor M1, the control bit can be increased.

According to such a digital television tuner according to the second embodiment of the present invention, the characteristics of a variable low-pass filter are set to be limited to several states. Specifically, the cut-off frequency of the variable low-pass filter 208 can be controlled, by an n-bit logic control line, to 2 to the nth power states and thus an AGC digital television tuner using an IF detection method can be composed that performs control of the 2 to the nth power states according to a receiving condition.

The second embodiment is the same as the first embodiment except for the above-described point.

### Third Embodiment

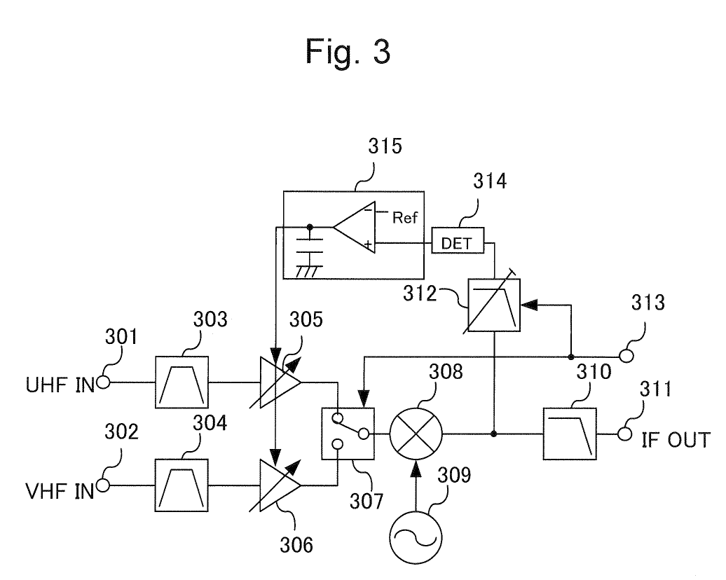

A digital television tuner according to a third embodiment of the present invention is shown in FIG. 3.

In FIG. 3, reference numeral 301 denotes an UHF input terminal that accepts, as input, an UHF signal received via an antenna, reference numeral 302 denotes a VHF input terminal that accepts, as input, a VHF signal received via an antenna, reference numeral 303 denotes an UHF bandpass filter, reference numeral 304 denotes a VHF bandpass filter, reference numeral 305 denotes a low-noise UHF variable gain amplifier (gain control amplifier), reference numeral 306 denotes a low-noise VHF variable gain amplifier (gain control amplifier), reference numeral 307 denotes a switching switch for UHF and VHF which is a mixer input, reference numeral 308 denotes a mixer, reference numeral 309 denotes a local oscillator, reference numeral 310 denotes a low-pass filter that allows an IF signal to pass therethrough, reference numeral 311 denotes an IF output terminal, reference numeral 312 denotes a variable low-pass filter disposed before a detector, reference numeral 313 denotes a VHF/UHF switching control terminal, reference numeral 314 denotes the detector, and reference numeral 315 denotes an AGC control circuit.

The operation of the digital television tuner configured in the above-described manner will be described.

First, an UHF signal inputted through the UHF input terminal 301 passes through the UHF bandpass filter 303 and is then amplified by the UHF variable gain amplifier (gain control amplifier) 305. A VHF signal inputted through the VHF input terminal 302 passes through the VHF bandpass filter 304 and is then amplified by the VHF variable gain amplifier (gain control amplifier) 306. One of the UHF and VHF signals amplified by the variable gain amplifiers 305 and 306, respectively, is selected by the switching switch 307. The selected signal is then inputted to an RF input of the mixer 308. An output signal from the local oscillator 309 is inputted to a local input of the mixer 308. The mixer 308 outputs a low-frequency IF signal which is a differential frequency between the RF signal and the local signal. The IF signal outputted from the mixer 308 passes through the low-pass filter 310 and is then outputted from the IF output terminal 311.

On the other hand, the IF signal outputted from the mixer 308 passes through the variable low-pass filter 312 and a level of the IF signal is detected by the detector 314. The signal detected by the detector 314 is inputted to the AGC control circuit 315. An output of the AGC control circuit 315 is connected to gain control terminals of the respective UHF variable gain amplifier 305 and VHF variable gain amplifier 306. In the AGC control circuit 315, an error amplifier (an operational amplifier in the AGC circuit) controls the variable gain amplifiers (gain control amplifier) such that a difference of a detector output voltage and a reference voltage Ref is constant. By the operation of the AGC control circuit 315, an AGC operation is performed to always suppress the output level of the mixer 308 to a certain value or less, regardless of whether a signal is an interfering wave or a desired wave.

By a signal inputted to the VHF/UHF switching control terminal 313, the switching switch 307 for UHF and VHF which is a mixer input is switched, and furthermore, the cut-off frequency of the variable low-pass filter 312 is set to be specified to a VHF or UHF state.

As described above, according to the digital television tuner according to the third embodiment, the variable low-pass filter 312 specifies either a VHF or UHF state, whereby the cut-off frequency is set; accordingly, an AGC digital television tuner using an IF detection method can be composed.

A specific description will be made below. The setting of the characteristics of the variable low-pass filter 312 is changed based on VHF or UHF. When VHF having lower frequencies is received, since interfering wave frequencies are also low and thus are present near a desired signal, the variable low-pass filter 312 does not need to have a wide band. In addition, to suppress, by the variable low-pass filter 312, an image signal (whose frequency is the sum of an RF frequency and a local oscillator frequency) generated in the mixer 308, the band of the variable low-pass filter 312 is set to a low value such that an image frequency is sufficiently attenuated. When UHF having higher frequencies and a wider band is received, to detect levels of interfering waves, the cut-off frequency of the variable low-pass filter 312 is set to a high value. Although an image frequency generated in the mixer 308 needs to be suppressed, the image frequency itself is high as compared with VHF and thus the cut-off frequency of the variable low-pass filter 312 is set to a high value. This enables an AGC function by an IF detection method. For example, in UHF, since the bandwidth is about 300 megahertz, upon reception of channel 13 at an end of the band, if there is an interfering signal of channel 62, the signal is about 300 megahertz and thus the cut-off frequency is set to 300 megahertz or higher. Upon reception of the VHF band, in a bandwidth of channels 4 to 12, the bandwidth is about 50 megahertz and thus an interfering signal of a maximum of 50 megahertz comes along; accordingly, the cut-off frequency is set to 50 megahertz or higher.

Note that although the variable low-pass filter has the same configuration as that described in the first embodiment, the configuration maybe the same as that described in the second embodiment.

### INDUSTRIAL APPLICABILITY

As described above, in view of the problem that analog interfering waves cannot be detected in an AGC circuit using an IF detection method, digital television tuners of the present invention define, according to digital television channels, analog television channels which are interfering waves, and set a cut-off frequency of a second low-pass filter such that levels of interfering analog television signals can be detected by a detector and that an unwanted signal that the detector does not want to detect is suppressed by a signal outputted from a mixer, and thereby provide an advantageous effect that levels of interfering waves can be detected. In addition, without increasing power consumption caused by the addition of an RF amplifier, which is the problem of an AGC circuit using an RF detection method, an AGC circuit of a digital television tuner is composed. Accordingly, the digital television tuners of the present invention are useful as digital television tuners suitable for mobile reception that require high-performance digital television reception with low power consumption, or the like.

What is claimed is:

1. A receiving apparatus comprising:
a gain control amplifier that amplifies a received RF signal;
a local oscillator;
a mixer that mixes an output signal from the gain control amplifier with an output signal from the local oscillator;
a first low-pass filter that extracts an IF signal from an output signal from the mixer;
a second low-pass filter that extracts a desired frequency component from the output signal from the mixer;
a detector that detects a level of an output signal from the second low-pass filter; and
an AGC control circuit that feeds back an output from the detector, as a gain control signal, to the gain control amplifier, wherein
a cut-off frequency of the second low-pass filter is changed according to a receiving condition.

2. The receiving apparatus according to claim 1, wherein the second low-pass filter has an n-bit logic control line and control of 2 to nth power states is performed according to control data to be provided to the n-bit logic control line, whereby the cut-off frequency is adjusted.

3. The receiving apparatus according to claim 1, wherein in the second low-pass filter, a state of the cut-off frequency is switched according to two reception states, VHF and UHF.

4. The receiving apparatus according to claim 2, wherein in the second low-pass filter, a state of the cut-off frequency is switched according to two reception states, VHF and UHF.
